(19) United States
(12) Patent Application Publication
(10) Pub. No.: US 2007/0187249 A1
(43) Pub. Date: Aug. 16, 2007

(54) Novel use of a positively charged support

(76) Inventor: Bengt Bjellqvist, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/584,365

(22) PCT Filed: Dec. 15, 2004
(86) PCT No.: PCT/SE04/01872

§ 371 Date: Jun. 23, 2006

(30) Foreign Application Priority Data
Dec. 23, 2003 (SE) 0303581-3

(51) Int. Cl. B01D 57/02; G01N 27/00

(52) U.S. Cl. 204/548; 204/644

(57) ABSTRACT

The present invention relates to a novel use of a positively charged support, namely as a sample loading support for loading samples onto an IPG (Immobilised pH gradient) gel. The support or paper is provided with positively charged groups, such as cation groups, and is used to load samples from the cathode side of the IPG gel. Furthermore, the invention relates to a kit comprising a positively charged sample application support as above and an IPG gel, preferably a pre-swollen RTG gel comprising an acidic pH-interval.

### CROSS REFERENCE TO RELATED ALLOCATIONS

This application is a filing under 35 U.S.C. [symbol] 371 and claims priority to international patent application number PCT/SE2004/001872 filed Dec. 15, 2004, published on Jul. 7, 2005, as WO 2005/062032, which claims priority to application number 0303581-3 filed in Sweden on Dec. 23, 2003; the disclosures of which are incorporated herein by reference in their entireties.

### FIELD OF THE INVENTION

The present invention relates to a novel use of a positively charged support. More closely, the invention relates to a sample loading support paper or membrane for loading samples onto an electrophoretic IPG (immobilised pH gradient) gel. The support is provided with positively charged groups and is used to load samples from the cathode side of the IPG gel or strip.

### BACKGROUND OF THE INVENTION

One type of widely used electrophoresis is isoelectric focussing, wherein substances, such as proteins, are separated according to their pI-value. For isoelectric focussing, sample loading has traditionally been performed by cup loading by placing a cup on the gel and letting a sample pass through the cup into the gel. The cup is positioned on the gel for the whole electrophoresis run.

Alternatively for dried gels, the sample may be mixed with electrophoresis buffer and used as a rehydration solution to rehydrate the dried gel, such as Immobiline DryStrip™ gels.

More recently, sample application paper in the form of conventional filter paper, has been placed between the electrode and the electrophoresis gel to load a sample into an electrophoretic gel. This functions satisfactorily for sample application from the anode side of the gel. However, this approach does not work when using acidic pH intervals. As an alternative, rehydration loading can be used in these pH intervals.

However, rehydration loading is not possible with swollen gels, such as pre-swollen RTG (ready-to-go) strips. Thus, these kinds of gels need an alternative loading, especially for application of large samples which is very difficult today.

Supports provided with positively charged groups are known within prior art. For example, U.S. Pat. No. 3,714,010 describes anion exchange membranes from cellulosic sheet materials such as cellophane, parchment paper or kraft paper. The membrane is especially suited for use in the electrodialytic purification of saline water.

U.S. Pat. No. 4,080,171 describes a method for analysis of trace components in a liquid, which comprises filtering said liquid through a filter paper having at least one anion exchange.

U.S. Pat. No. 5,151,189 describes a cationic charge modified microporous membrane. This membrane can be used in various applications such as filtration of fluids and macromolecular transfer from electrophoresis gels. The transfer process, also known as “blotting”, is defined herein as the steps involved in physically moving biomolecules from a gel matrix to a microporous membrane onto which they become immobilised.

The most common prior use of anion exchange supports within prior art has been the use of anion exchange paper for chromatography purposes. Examples of this are DEAE-cellulose paper and aminoethyl-cellulose paper.

According to our knowledge there is no prior art describing IPG electrophoresis sample loading with positively charged support.

### BRIEF DESCRIPTION OF THE INVENTION

The present invention provides an alternative way to load samples onto electrophoretic IPG gels. The invention enables sample loading from the cathode side of the IPG gel or strip. According to the invention sample is applied to an acidic interval IPG gel or strip, such as a RTG (ready-to-go) strip. This novel application enables sample loading in preparative amounts of protein.

The above was achieved according to the invention by providing use of a positively charged support for sample application from the cathode side of the gel. Thus, the invention provides a new method of using a positively charged support.

Thus, in a first aspect, the invention relates to use of a hydrophilic support derivatised with positively charged groups, for sample application to electrophoretic gels, such as IPG (Immobilised pH gradient) gels. According to the invention the application is performed from the cathode side of the electrophoretic gel.

The support is preferably made of regenerated cellulose, dextran, agarose, polyvinylalcohol, polyether sulfone, polysulfone, cellulose acetate, polyurethane, polyamide, nylon or other types of membranes and composite membranes.

Preferably, the positively charged groups are cation groups. The degree of substitution with cation groups on the support may not cause adsorption of substances present in the sample, such as proteins, to the support.

Preferably, the cation groups are quartenary groups, such as QAE or Q groups, or DEAE.

In the currently best mode, a preferred support is made of regenerated cellulose substituted with a low degree of quaternary groups, preferably Q-groups.

In a preferred embodiment, the IPG gel is an acidic interval (such as pH 3.5-5) IPG gelor strip. One type of preferred IPG strips are RTG (ready-to-go) strips. RTG-strips are pre-swollen gels available in different pH-intervals.

The sample applicator according to the invention may be used in analytical as well as preparative amounts, a preferred use is for application of samples in preparative amounts.

The sample applicator may be used for application of samples to IPG gels per se or used for 2D gels, wherein the first dimension is isoelectric focussing and the second dimension is according to molecular weight.

In a second aspect, the invention relates to a kit comprising a positively charged sample application support according the above and an IPG gel, preferably a pre-swollen RTG strip, and more preferably an acidic interval RTG-strip, such as pH 3.5-5, pH 3.5-4.5 or pH 4-5.

In a third aspect, the invention relates to a sample applicator for IPG electrophoresis comprising regenerated cellulose derivatised with cation groups, preferably Q-groups.

### DETAILED DESCRIPTION OF THE INVENTION

The present invention provides novel use of a positively charged support, namely as a sample applicator in IPG electrophoresis. According to the invention the support is a hydrophilic support with high water absorbing capacity. Preferably the support can hold a large sample volume, such as 1 ml sample. The amount of sample added to the support is usually from 50 μl-10000 μl in a concentration of up to 10 mg/mi. The support must be substantially inert to the substances, such as proteins, present in the sample.

The support is made of any material with high water absorbing capacity, such as, but not limited to, regenerated cellulose, dextran, agarose, polyvinylalcohol, polyether sulfone, polysulfone, cellulose acetate, polyurethane, polyamide, nylon or other types of membranes and composite membranes.

According to the present invention, the support is substituted with positively charged cation groups, such as DEAE (diethylaminoethyl) or quaternary groups (for example Q (quaternary ammonium) or QAE (quaternary aminoethyl) groups) to give the paper a positive charge and anionic exchange character. This support can be used for application of samples from the cathode side of the gel.

The technique for derivatising the support or paper is known per se and can be found, for example, in “Membrane chromatography: Preparation and Applications to Protein Separation” Xianfang Zeng, Eli Ruckenstein; Biotechnol. Prog. 1999, 15, 1003-1019.

A preferred support is made of regenerated cellulose (paper) substituted with a low degree of quaternary ammonium groups, preferably Q-groups.

The thickness of the support depends on the support material. For regenerated cellulose (paper) the thickness is preferably 3-4 mm. The dimensions of the support are determined by the size of the gel and the sample amount.

The sample loading support according to the invention may be used in association with any swollen electrophoretic gel, preferably an IPG gel. The sample is added to the support and thereafter it is placed between the cathode and the electrophoresis gel. At one end the support is in contact with the cathode and at the other end in contact with the cathode side of the gel. The running conditions are the same as for any IPG run or 2D electrophoresis run.

When using conventional cup loading, there are often disturbances in the first 15% of the gradient due to the presence of the cup. For short IPG strips this may be a very significant portion of the gel. With the present invention this problem is avoided.

The sample may be loaded in analytical or preparative amounts. The sample may be a biological sample or any other sample.

The present invention is especially suited for application of large sample amounts up to 1 ml and up to 10 mg/ml and is therefore very useful for preparative runs of large amounts of sample, preferably large amounts of protein.

### EXAMPLES

Below, the present invention will be explained in more detail by way of examples, which however are not to be construed as limiting the present invention as defined by the appended claims. All references given below and elsewhere in the present specification are hereby included herein by reference. Although DEAE-groups are mentioned as an exemplifying group, the skilled person could easily employ for example Q-groups instead.

Cleangel Electrode strip was used as a paper bridge for sample application. This matrix is a paper made of pure cotton linters. Thus, the alpha cellulose content exceeds 98% and the remaining percentage consists of beta and gamma cellulose.

TABLE 1

| Chemicals | Supplier | Article no. | Batch no. |
|---|---|---|---|
| Clean Gel | Schleicher & | 18-1035-33 | |
| Electrode Strips | Schüll | | |
| Synthesis of | | | |
| ion-exchanger paper | | | |
| Diethyl amino | Amersham | | |
| ethyl-chloride, 65% | Biosciences | | |
| Sodiumhydroxide 0.01 M | Merck | | |
| Ethanol 99.5% | Kemetyl | | |
| Iso-electric focusing | | | |
| Immobiline | Amersham | | |
| DryStrip pH 3-5.6 | Biosciences | | |
| IPG buffer 3-5.6 | | | |
| Urea 6M | | | |
| Thiourea 2M | | | |
| Chaps 2% | | | |
| DeStreak | Amersham | | |
| IPGbuffer 3-10 | Biosciences | | |
| DTT 40 mM | | | |

Synthesis of Ion Exchangers

The cellulose paper was cut into pieces of approximately 1×2.8 cm and placed into a 20 ml glass vial. The paper pieces were soaked in distilled water (15 ml) and pH was adjusted to >10 with sodium hydroxide. The reaction was started by addition of diethylaminoethylchloride (DEAE, see Table 2 below). The reaction vessels were placed at a shaking table and the reaction proceeded for approximately 19 hours (at room temperature) before neutralization with acid (1 M hydrochloric acid or 1M acetic acid). The papers were washed repeatedly with acid (120 ml), ethanol (720 ml) and water (300 ml) both ultrasonically and on a glass filter. The paper pieces were dried under vacuum over night.

TABLE 2
Amount DEAE-chloride in relation to cellulose paper

| | Paper | DEAE-chloride | DEAE-chloride | NaOH |
|---|---|---|---|---|
| ID | g | w/w %* | mmol | mmol |
| U1275004:01 | 1.51 | 4 | 0.287 | 0.750 |
| U1275004:02 | 1.56 | 21 | 1.44 | 3.75 |
| U1275004:03 | 1.56 | 44 | 2.86 | 7.50 |
| U1275004:04 | 1.52 | 65 | 4.31 | 11.25 |
| U1275006:01 | 1.1244 | 1 | 0.058 | 0.012 |
| U1275006:02 | 1.068 | 0.6 | 0.029 | 0.006 |
| U1275006:03 | 1.1903 | 0.3 | 0.014 | 0.003 |
| U1275006:04 | 1.1429 | 0.1 | 0.007 | 0.0015 |

*w/w % DEAE-chloride in relation to the weight of paper.

Isoelectric Focusing in Immobiline DryStrip 3-5.6

Immobiline DryStrip pH 3-5.6 were run according to the instructions of the manufacturer. The strips were rehydrated with 0.5% IPG buffer 3-5.6, 6 M urea, 2 M thiourea, 2% chaps and DeStreak.

The following sample was soaked into each paper bridge: 220 μl/strip of: 20 μl E. coli extract+200 μl sample buffer 0.5% IPG buffer 3-10, 40 mM DTT, 6 M urea, 2 M thiourea, 2% chaps.

TABLE 3
Results from iso-electric focusing

| | | | Measured | Results in IPG | |
|---|---|---|---|---|---|
| | | Added | conc of | strip pH | |
| | | conc of | DEAE* | 3-5.6 | |
| Paper ID | Experiment | DEAE | w/w % | Anode | Cathode |
| U1275004:1 | 040518 | 4 | 0.06 | −− | −−− |
| U1275004:2 | 040518 | 21 | 0.23 | −− | −−− |
| U1275004:3 | 040518 | 44 | 0.34 | −−− | −−− |
| U1275004:4 | 040518 | 65 | 0.36 | − | −−− |
| U1275006:1 | 040602 | 1 | 0.013 | − | ++ |
| U1275006:2 | 040602 | 0.6 | a | 0 | ++ |
| U1275006:3 | 040602 | 0.3 | a | 0 | + |
| U1275006:4 | 040602 | 0.1 | a | 0 | + |
| Original paper | 040518/040602 | 0 | 0 | 0 | 0 |

*Concentration measured by elemental analysis of CHN at Mikrokemi AB, Uppsala, SE

Key to results

| | |
|---|---|
| 0 | Results as in original paper |
| + | Better than original paper |
| ++ | Best paper tested |
| −−− | No visible bands |
| a | Too low conc. for analysis method |

The original paper (0, see Table 2) gave about the same results when sample were applied at the anode or by in gel rehydration loading. Original paper applied at the cathode gave only weak acidic protein band.

The results indicate that the substitution degree of DEAE groups cannot be too high. For the four first mentioned papers the substitution degree was far too high and the paper was acting as a strong ion exchanger thus binding the proteins. This was indicated by the hard adsorption of marker stain Bromophenolblue to the paper. The stain did not/slowly migrated out of the paper during the electrophoresis.

It is apparent that many modifications and variations of the invention as hereinabove set forth may be made without departing from the spirit and scope thereof. The specific embodiments described are given by way of example only, and the invention is limited only by the terms of the appended claims.

1. A method for sample application to an acidic interval IPG (immobilised pH gradient) gel, comprising
(a) placing a hydrophilic support between the cathode and the cathode side of the gel; and
(b) applying said sample onto said hydrophilic support;
wherein said hydrophilic support is derivatised with positively charged groups.

2. The method of claim 1, wherein the support is made of regenerated cellulose, dextran, agarose, polyvinylalcohol, polyether sulfone, polysulfone, cellulose acetate, polyurethane, polyamide, nylon or other types of membranes and composite membranes.

3. The method of claim 1, wherein the positively charged groups are cation groups.

4. The method of claim 3, wherein the cation groups are quaternary groups.

5. The method of claim 4, wherein the quaternary groups are QAE or Q groups.

6. The method of claim 5, wherein the cation groups are DEAE-groups.

7. The method of claim 1, wherein the IPG gel is a pre-swollen RTG (ready-to-go) gel.

8. The method of claim 1, wherein the support is made of regenerated cellulose derivatised with quaternary groups.

9. The method of claim 8, wherein the quaternary groups are Q-groups.

10. The method of claim 1, wherein the sample is applied in preparative amounts.

11. The method of claim 1 as a first step in 2D electrophoresis.

12. A kit comprising a positively charged sample application support and an acidic interval IPG gel or strip.

13. The kit of claim 12, wherein the IPG gel is a RTG-gel.

14. The kit of claim 12, wherein the acidic interval is pH 3.5-5.

15. The kit of claim 12, wherein the support is made of regenerated cellulose derivatised with Q-groups.

16. A sample applicator for acidic interval IPG electrophoresis, comprising regenerated cellulose derivatised with cation groups.

17. The sample applicator of claim 16, comprising regenerated cellulose derivatised with Q-groups.
